(19) United States
(12) Patent Application Publication
(10) Pub. No.: US 2011/0035335 A1
(43) Pub. Date: Feb. 10, 2011

(54) Apparatus, System, Method, and Computer Readable Medium for Providing Suggestions

(75) Inventor: Masatoshi YAMAMOTO, Kahoku-shi (JP)

Correspondence Address: Hogan Lovells US LLP, 1999 AVENUE OF THE STARS, SUITE 1400, LOS ANGELES, CA, 90067, US

(73) Assignee: PFU LIMITED, Kahoku-shi (JP)

(21) Appl. No.: 12/834,394

(22) Filed: Jul. 12, 2010

(30) Foreign Application Priority Data
Aug. 6, 2009 (JP) 2009-183910

(51) Int. Cl. G06F 17/00

(52) U.S. Cl. 705/400

(57) ABSTRACT

There is provided an apparatus for providing suggestions including a memory that stores print attribute information indicating contents of printing processes in a print attribute information database, an obtaining unit that obtains print attribute information of a group of printing processes designated by a user from the print attribute information database, an alternative selection unit that selects an alternative means applicable to each of the group of printing processes based on the print attribute information obtained by the obtaining unit, an actual cost calculation unit that calculates a print cost required for the group of printing processes based on the print attribute information obtained by the obtaining unit, an alternative cost calculation unit that calculates a print cost that would incur if the group of printing processes were executed with the alternative means selected by the alternative selection unit being applied based on the print attribute information obtained by the obtaining unit, and a suggestion unit that presents an improvement suggestion on printing processes based on the print cost calculated by the actual cost calculation unit and the print cost calculated by the alternative cost calculation unit.

### CROSS-REFERENCE TO RELATED APPLICATIONS

This application is based on and claims priority under 35 USC 119 from Japanese Patent Application No. 2009-183910 filed Aug. 6, 2009.

### BACKGROUND

The present invention relates to an apparatus, system, method, and computer readable medium for providing suggestions.

### SUMMARY

According to an aspect of the invention, there is provided an apparatus for providing suggestions including a memory that stores print attribute information indicating contents of printing processes in a print attribute information database, an obtaining unit that obtains print attribute information of a group of printing processes designated by a user from the print attribute information database, an alternative selection unit that selects an alternative means applicable to each of the group of printing processes based on the print attribute information obtained by the obtaining unit, an actual cost calculation unit that calculates a print cost required for the group of printing processes based on the print attribute information obtained by the obtaining unit, an alternative cost calculation unit that calculates a print cost that would incur if the group of printing processes were executed with the alternative means selected by the alternative selection unit being applied based on the print attribute information obtained by the obtaining unit, and a suggestion unit that presents an improvement suggestion on printing processes based on the print cost calculated by the actual cost calculation unit and the print cost calculated by the alternative cost calculation unit.

### BRIEF DESCRIPTION OF THE DRAWINGS

Exemplary embodiments of the present invention will be described in detail based on the following figures, wherein:

FIG. 1 is a diagram illustrating an entire configuration of a print suggestion system 1;

FIG. 2 is a diagram illustrating a functional configuration of a print data collection program 100;

FIG. 3 is a diagram illustrating a functional configuration of a print suggestion program 200;

FIG. 4 is a diagram illustrating data items of a print attribute information DB 206;

FIG. 5 is a diagram illustrating data items of a print cost DB 214;

FIG. 6 is a diagram illustrating a handling option DB 216;

FIG. 7 is a flowchart illustrating a print-based suggestion process S10;

FIG. 8 is a flowchart illustrating a device-based suggestion process S20; and

FIGS. 9A and 9B are diagrams illustrating entire configurations of print suggestion systems 2 and 3 in Modified Example 1.

### DETAILED DESCRIPTION

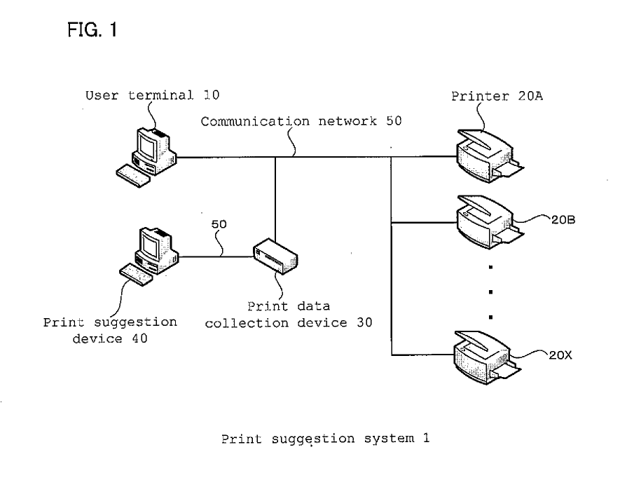

FIG. 1 is a diagram illustrating an entire configuration of a print suggestion system 1.

As illustrated in FIG. 1, the print suggestion system 1 includes a print data collection device 30 and a print suggestion device (suggestion apparatus) 40. The print data collection device 30 is connected to a communication network 50, to which a user terminal 10 and printers 20 are connected. The print suggestion device 40 is connected to the print data collection device 30 via the communication network 50. The communication network 50 is a wired or wireless LAN (Local Area Network) or the like.

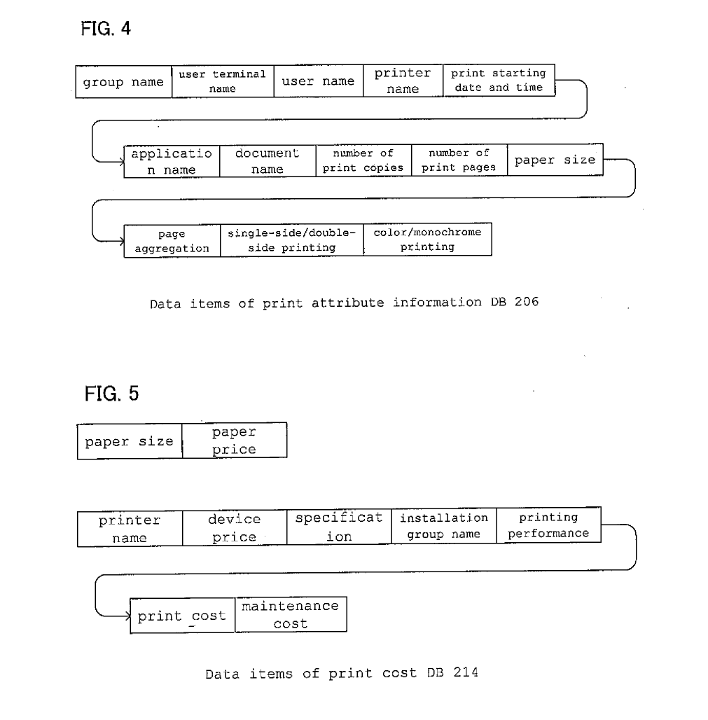

The user terminal 10 is a computer including a CPU and a data storage medium or the like, to which a printer driver has been installed. The user terminal 10 converts document data or the like edited by a user into print data and sends the data to a printer 20 by means of the installed printer driver. Print data is data that gives instructions to the printer 20 on print image and it is written in PDL (Page Description Language) or the like. In this embodiment, the print data includes print attribute information (to be described later using FIG. 4) indicative of the contents of a printing process.

The printer 20 receives print data from the user terminal 10 and performs printing in accordance with the received print data. In the example here, a plurality of printers 20A to 20X are connected to the same LAN.

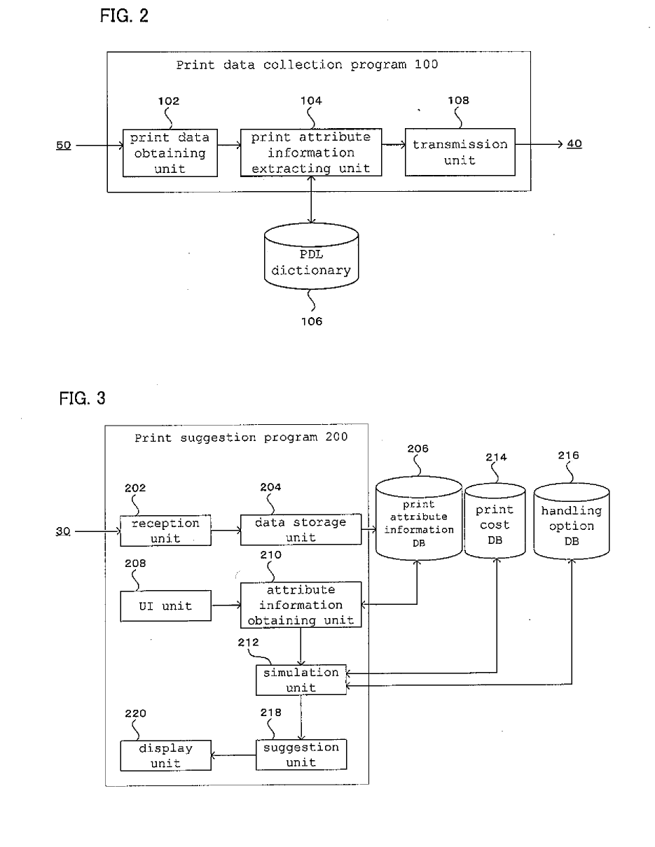

The print data collection device 30 includes a CPU and a data storage medium or the like, and executes a print data collection program 100 (to be described later using FIG. 2). The print data collection device 30 obtains print data exchanged between a user terminal 10 and a printer 20 from the communication network 50, to which the user terminal 10 and printer 20 are connected. In particular, the print data collection device 30 in this example obtains print data on the LAN in an environment in which a plurality of printers 20 of different vendors are mixedly present.

The print data collection device 30 extracts print attribute information from the obtained print data and sends the extracted print attribute information to the print suggestion device 40.

The print suggestion device 40 is a computer including a CPU and a data storage medium or the like, and executes a print suggestion program 200 (to be described later using FIG. 3). The print suggestion device 40 receives print attribute information from the print data collection device 30 and stores the received print attribute information in a print attribute information database (to be described later using FIG. 4). The print suggestion device 40 then presents improvement suggestions on the printing process based on the print attribute information stored in the print attribute information database.

As described above, the print suggestion system 1 can present improvement suggestions for reducing print cost in an existing network printing environment by means of the print suggestion device 40 connected to the print data collection device 30 via the communication network, this being achieved only by connecting the print data collection device 30 to the existing network printing environment where the user terminal 10 and printer 20 and the like are connected.

FIG. 2 is a diagram illustrating a functional configuration of the print data collection program 100.

As illustrated in FIG. 2, the print data collection program 100 includes a print data obtaining unit 102, a print attribute information extracting unit 104, and a transmission unit 108. The print data collection program 100 is configured to access a PDL dictionary 106. The print data collection program 100 is executed using hardware resources (such as a CPU and a data storage medium) of the print data collection device 30.

Hereinafter, each of the constituent units of the print data collection program 100 will be described.

The print data obtaining unit 102 obtains print data from the communication network 50. In this embodiment, the print data obtaining unit 102 constantly monitors the communication network 50 and captures a packet that contains print data exchanged between a user terminal 10 and a printer 20 via the communication network 50. The print data obtaining unit 102 then obtains print data from the captured packet. The print data obtaining unit 102 determines whether or not the packet contains print data based on, for example, a source IP address, a destination IP address, a source port number, a destination port number, or the like.

The print attribute information extracting unit 104 extracts print attribute information from the packet containing print data that has been obtained by the print data obtaining unit 102. Here, print attribute information means information indicating the contents of a printing process, including, for example, a user terminal name, or a user name, of the user who has requested the printing process, a name of the printer that executes the printing process, print starting date and time indicating the date and time when the printing process is started, a document name of document data to be printed, text data (title or contents) contained in the document data to be printed, a font size, a number of print copies, a number of print pages, and a paper size of this text data, information designating an aggregation of pages, information designating single-side printing or double-side printing, and information designating color printing or monochrome printing. In this embodiment, the print attribute information extracting unit 104 identifies the type of format of the print data by referring to the PDL dictionary 106, and extracts print attribute information from the print data in accordance with the identified type of format. The PDL dictionary 106 stores information representing a plurality of types of PDL formats that differ for each printer vendor or the like. The PDL dictionary 106 of this example stores a table that associates PDL of respective printer vendors with PDL in a default format, so that the print attribute information extracting unit 104 looks up this table to convert obtained print data (PDL file) into a PDL file in a default format and to extract print attribute information from the converted PDL file.

The transmission unit 108 sends the print attribute information extracted by the print attribute information extracting unit 104 to the print suggestion device 40 via the communication network 50.

FIG. 3 is a diagram illustrating a functional configuration of the print suggestion program 200.

As illustrated in FIG. 3, the print suggestion program 200 include a reception unit 202, a data storage unit 204, a UI unit 208, an attribute information obtaining unit 210, a simulation unit 212, a suggestion unit 218, and a display unit 220. The print suggestion program 200 is configured to access a print attribute information database (print attribute information DB) 206, a print cost database (print cost DB) 214, and a handling option database (handling option DB) 216. The print suggestion program 200 is executed using hardware resources (such as a CPU and a data storage medium) of the print suggestion device 40.

Hereinafter, each of the constituent units of the print suggestion program 200 will be described.

The reception unit 202 receives the print attribute information sent by the transmission unit 108 of the print data collection program 100 via the communication network 50.

The data storage unit 204 (storage means) stores the print attribute information received by the reception unit 202 in the print attribute information DB 206.

The UI unit 208 accepts information input by the user. In this embodiment, the UI unit 208 accepts conditions or the like indicating print attribute information of a group of printing processes for which improvement suggestions on printing are to be presented, as an input from the user. In other words, the UI unit 208 accepts a designation of a group of printing processes that will be the target of presentation of suggestions. User input means may be any suitable means such as a keyboard or a mouse.

The attribute information obtaining unit 210 (obtaining means) obtains print attribute information of the group of printing processes designated by the user from the print attribute information DB 206. In this embodiment, the attribute information obtaining unit 210 obtains print attribute information of the group of printing processes that matches the conditions accepted by the UI unit 208 from the print attribute information DB 206. The attribute information obtaining unit 210 then classifies the obtained print attribute information according to the types of documents or printer names or the like and sums up the number of print copies and number of print pages for each classification category.

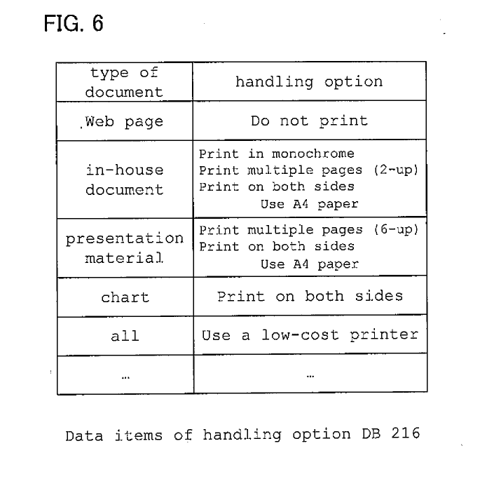

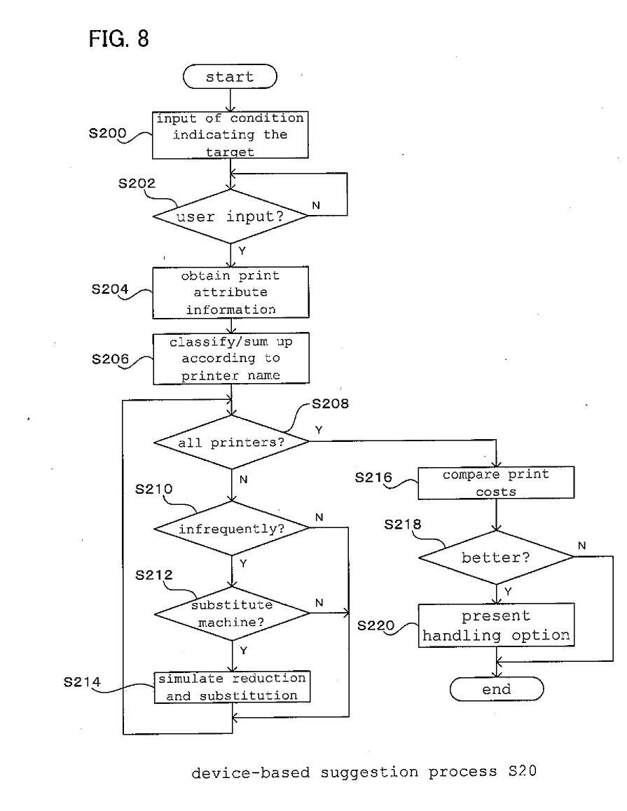

The simulation unit 212 selects (alternative selection means) handling options (alternative means) applicable to the group of printing processes based on the print attribute information obtained by the attribute information obtaining unit 210. In this embodiment, the simulation unit 212 selects handling options from the handling option DB 216 (to be described later using FIG. 6) corresponding to the type of document applicable to the group of printing processes. The simulation unit 212 also selects handling options corresponding to the condition in which printing devices are being used and applicable to the group of printing processes (to be described later using FIG. 8).

The simulation unit 212 then calculates a print cost that has been necessary for the group of printing processes (hereinafter referred to as “actual print cost”) based on the print attribute information obtained by the attribute information obtaining unit 210 (actual cost calculation means). The simulation unit 212 then calculates a print cost that would incur if the group of printing processes were executed with a selected handling option being applied (hereinafter referred to as “alternative print cost”) based on the print attribute information obtained by the attribute information obtaining unit 210 (alternative cost calculation means). In this embodiment, the simulation unit 212 calculates the print cost by referring to the print cost DB 214 (to be described later using FIG. 5).

The suggestion unit 218 presents improvement suggestions on the printing processes based on the actual print cost and alternative print cost calculated by the simulation unit 212. In this embodiment, the suggestion unit 218 compares the actual print cost with the alternative print cost and if the alternative print cost is lower than the actual print cost, i.e. if the print cost will be improved from that of the current situation, then it presents handling options that have been applied to work out the alternative print cost.

The display unit 220 displays the handling options presented by the suggestion unit 218 on an output device such as a display. Alternatively, it may output the handling options to a file together with a graph or a table showing cost changes or the like.

FIG. 4 is a diagram illustrating data items of the print attribute information DB 206.

As illustrated in FIG. 4, the data items of the print attribute information DB 206 are: group name, user terminal name, user name, printer name, print starting date and time, application name, document name, number of print copies, number of print pages, paper size, page aggregation, single-side/double-side printing, and color/monochrome printing. Data items of the print attribute information DB 206 should not be limited to these, and the items only need to contain at least the information indicating the content of a printing process.

Hereinafter, each of the data items of the print attribute information DB 206 will be described.

The group name represents a name of a department or floor which the user belongs to. The group name is specified by obtaining information from a system that manages user information (such as Active Directory), or by a given keyword designated for each of the print data collection devices.

The user terminal name is information that represents a name for identifying the user terminal 10. For example, the user terminal name is the name of a computer or a host.

The user name is information that represents a name for identifying the user who is using the user terminal 10.

The printer name is information that represents a name for identifying the printer 20.

The print starting date and time represents a date and a time when an instruction to execute the printing was given at the user terminal 10. The print ending date and time for the same printing process is associated with the starting date and time and also stored in the print attribute information DB 206. The print ending date and time is detected, for example, by monitoring data that the printer 20 sends to notify the user terminal 10 of the end of printing.

The application name is information that represents a name of the application that gave the instruction to execute the printing at the user terminal 10. The application name is, for example, specified by a specific keyword (such as “http:”, “pdf”, and “xls”) found in a document name by conducting a prefix, suffix, or partial search.

The document name is information that represents a name for identifying a document to be printed. For example, the document name is a file name or title name of the document to be printed.

The number of print copies is information that represents a number of copies of the document to be printed.

The number of print pages is information that represents a number of pages of the document to be printed.

The paper size is information that represents a size of the paper that will be printed.

The page aggregation is information that represents a number of pages of a document to be included on one page of paper that will be printed.

The single-side/double-side printing is information that designates whether the paper will be printed on one side or on both sides.

The color/monochrome printing is information that designates whether the paper will be printed in color or in monochrome.

FIG. 5 is a diagram illustrating data items of the print cost DB 214.

As illustrated in FIG. 5, the data items of the print cost DB 214 are divided into two tables. The data items of the first table consist of paper size and paper price. The data items of the second table consist of printer name, device price, specification, installation group name, printing performance, print cost, and maintenance cost. Data items of the print cost DB 214 should not be limited to these, and the items only need to contain at least the information for calculating a print cost based on the print attribute information.

Hereinafter, each of the data items of the print cost DB 214 will be described.

The paper size corresponds to the paper size of the print attribute information DB 206.

The paper price is information representing a price of paper corresponding to the paper size.

The printer name corresponds to the printer name of the print attribute information DB 206.

The device price is information representing a price of the printer 20.

The specification is information representing a specification of the printer 20. For example, the specification indicates a bottom surface area of the printer 20.

The installation group name is information representing a name of a group assigned to a location where the printer 20 is installed. For example, the installation group name represents a name of a department or a floor in a corporation where the printer is installed.

The printing performance is information representing a number of printed sheets per a unit hour. In this embodiment, the printing performance is set for each of the color printing and monochrome printing.

The print cost is information representing a cost (price) per sheet required for printing. In this embodiment, the print cost is set for each of the color printing and monochrome printing.

The maintenance cost is information representing a cost required for regular maintenance of the printer 20.

With this print cost DB 214 described above, the simulation unit 212 can calculate the actual print cost and alternative print cost based on the print attribute information.

FIG. 6 is a diagram illustrating the handling option DB 216.

As illustrated in FIG. 6, the data items of the handling option DB 216 consist of types of documents and handling options. The data items of the handling option DB 216 should not be limited to these, and they only need to contain at least the information representing handling options for each type of document.

Hereinafter, each of the data items of the handling option DB 216 will be described.

The type of document is information representing types of documents to be printed. In this embodiment, the type of document includes Web pages, electronic mails, in-house documents, presentation materials, charts, and “all” (including all documents).

The handling options are information indicating improvement suggestions for each type of document. In this embodiment, the handling options are set as: “Do not print” for a Web page or electronic mail; “Print in monochrome”, “Print multiple pages (2-up)”, “Print on both sides”, and “Use A4 paper” for an in-house document; “Print multiple pages (6-up)”, “Print on both sides”, and “Use A4 paper” for a presentation material; “Print on both sides” for a chart, and “Use a low-cost printer” for “all”. Note that the information set as the types of documents and handling options varies depending on the printing environment.

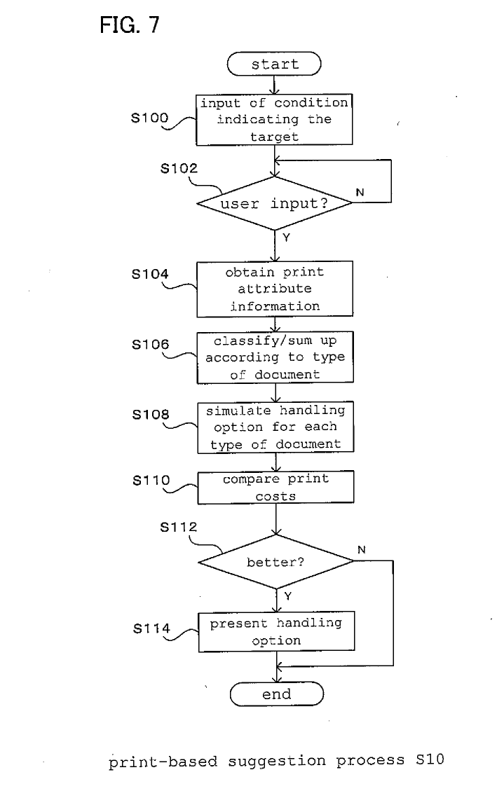

FIG. 7 is a flowchart illustrating a print-based suggestion process S10.

As illustrated in FIG. 7, at step 100 (S100), the UI unit 208 accepts an input of conditions from the user indicating print attribute information of a group of printing processes for which improvement suggestions on printing are to be presented. In this embodiment, the “conditions indicating print attribute information of a group of printing processes for which improvement suggestions on printing are to be presented” are represented by a combination of group name, user terminal name, user name, printer name, or print starting date and time.

At step 102 (S102), the UI unit 208 determines whether or not an input from the user has been accepted. The print suggestion program 200 proceeds to S104 if an input from the user has been accepted, and returns to S102 if an input from the user has not been accepted.

At step 104 (S104), the attribute information obtaining unit 210 obtains print attribute information that matches the conditions input by the user at S102 from the print attribute information DB 206.

At step 106 (S106), the attribute information obtaining unit 210 classifies the print attribute information obtained at S104 according to the types of documents and sums up the number of print copies and number of print pages or the like for each classification category. The attribute information obtaining unit 210 determines the type of document from an application name contained in the print attribute information and a specific keyword contained in a document name.

At step 108 (S108), the simulation unit 212 selects a handling option from the handling option DB 216 in accordance with the type of document applicable to the group of printing processes. The simulation unit 212 then calculates an actual print cost and an alternative print cost based on the print attribute information classified or summed up at S106.

At step 110 (S110), the suggestion unit 218 compares the actual print cost and alternative print cost calculated at S108.

At step 112 (S112), as a result of comparison at S110, the suggestion unit 218 determines whether or not the alternative print cost is lower than the actual print cost, i.e., whether or not the print cost will be improved from that of the current situation. If it is determined that the print cost will be better than that of the current situation, the print suggestion program 200 proceeds to S114, while, if the print cost will not be better than that of the current situation, the program ends.

At step 114 (S114), the suggestion unit 218 presents the handling option applied when calculating the alternative print cost at S108. At this time, preferably, the suggestion unit 218 may display both the actual print cost and alternative print cost side by side together with the handling option so as to show the effect of cost reduction.

FIG. 8 is a flowchart illustrating a device-based suggestion process S20.

As illustrated in FIG. 8, at step 200 (S200), the UI unit 208 accepts an input of conditions from the user indicating print attribute information of a group of printing processes for which improvement suggestions on printing are to be presented.

At step 202 (S202), the UI unit 208 determines whether or not an input from the user has been accepted. The print suggestion program 200 proceeds to S204 if an input from the user has been accepted, and returns to S202 if an input from the user has not been accepted.

At step 204 (S204), the attribute information obtaining unit 210 obtains print attribute information that matches the conditions input by the user at S202 from the print attribute information DB 206.

At step 206 (S206), the attribute information obtaining unit 210 classifies the print attribute information obtained at S204 according to the printer name and sums up the number of print copies and number of print pages or the like for each classification category.

At step 208 (S208), the simulation unit 212 determines whether or not the process steps of S210 to S214 have been executed with regard to the print attribute information classified or summed up at S206 for all the classified printers. If the process steps have been executed for all the classified printers, the print suggestion program 200 proceeds to S216, while, if the process steps have not been executed for all the classified printers, the print suggestion program 200 returns to S210.

At step 210 (S210), the simulation unit 212 calculates run time for each of the classified printers from the starting date and time and ending date and time of the printing contained in the print, attribute information classified or summed up at S206. The simulation unit 212 then determines whether or not each of the classified printers is being used infrequently based on the calculated run time. In this embodiment, if the calculated run time is shorter than a predetermined time period, the simulation unit 212 determines that the printer having this run time is being used infrequently. If the printer is being used infrequently, the print suggestion program 200 proceeds to S212, while if the printer is being used not infrequently, it proceeds to S208.

At step 212 (S212), the simulation unit 212 determines whether or not a substitute machine (printer) of the printer that has been determined to be used infrequently at S210 is present within the same installation group as the printer in question. In this embodiment, the substitute machine allows for the run time of the printer that has been determined to be used infrequently at S210. If there is a substitute machine within the same installation group, the print suggestion program 200 proceeds to S214, while if there is no substitute machine within the same installation group, it proceeds to S208.

At step 214 (S214), the simulation unit 212 calculates an actual print cost and an alternative print cost that would incur if the printer that has been determined to be used infrequently at S210 was removed, or, if it was substituted with the substitute machine specified at 8212, based on the print attribute information classified or summed up at S206.

At step 216 (S216), the suggestion unit 218 compares the actual print cost and alternative print cost calculated at S214.

At step 218 (S218), as a result of comparison at S216, the suggestion unit 218 determines whether or not the alternative print cost is lower than the actual print cost, i.e., whether or not the print cost will be improved from that of the current situation. If it is determined that the print cost will be better than that of the current situation, the print suggestion program 200 proceeds to S220, while, if the print cost will not be better than that of the current situation, the program ends.

At step 220 (S220), the suggestion unit 218 presents a handling option (removal or substitution) applied when calculating the alternative print cost at S214. At this time, preferably, the suggestion unit 218 may display both the actual print cost and alternative print cost side by side together with the handling option so as to show the effect of cost reduction.

With the configurations and operations described above, the print suggest system 1 not only presents the condition in which the printer is being used and the print cost as in prior art, but also presents an improvement suggestion for reducing the print cost in accordance with the condition in which the printer is being used. Thereby, while in the past it would require an expert's analysis to find out an improvement suggestion for reducing print cost from the condition in which the printer is used and the actual print cost, this print suggestion system 1 obviates this necessity. In other words, anyone can readily reduce a current print cost by following an improvement suggestion presented by the print suggestion system 1.

### Modified Example 1

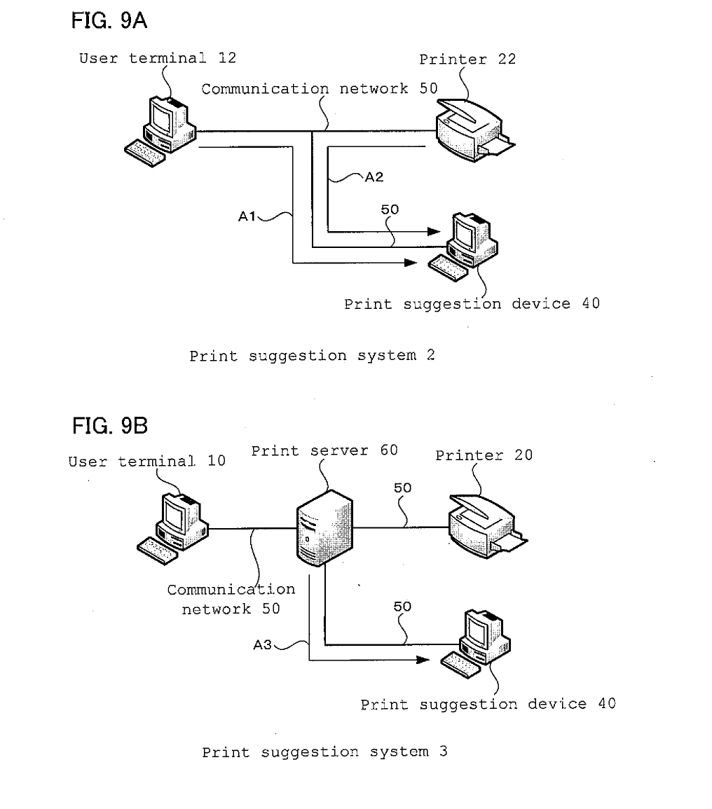

FIG. 9A and FIG. 9B are diagrams illustrating entire configurations of print suggestion systems 2 and 3 in Modified Example 1.

As illustrated in FIG. 9A, the print suggestion system 2 includes a user terminal 12, a printer 22, and a print suggestion device 40. The user terminal 12 and printer 22 are connected to the printer 20 and print suggestion device 40 via the communication network 50.

In the previously described embodiment, as a specific example, the print data collection device 30 was described as being present as a separate device, but as illustrated in FIG. 9A, the functions of the print data collection device 30 may be provided inside the user terminal. More particularly, the user terminal 12 in this modified example is the user terminal 10 of the above-described embodiment, with the print data collection program 100 installed therein. In this case, the print data obtaining unit 102 of the print data collection program 100 obtains print data output by a printer driver installed in the user terminal 12. The user terminal 12 sends print attribute information extracted from the obtained print data by the installed print data collection program 100 to the print suggestion device 40 via the communication network 50. Reference numeral A1 indicates a communication path of the print attribute information sent from the user terminal 12 to the print suggestion device 40.

Alternatively, the functions of the print data collection device 30 may be provided inside a printer 22. More particularly, the printer 22 shown in FIG. 9A may be the printer 20 of the above-described embodiment, with the print data collection program 100 installed therein. In this case, the print data obtaining unit 102 of the print data collection program 100 obtains print data the printer 22 received from the user terminal 12. The printer 22 sends print attribute information extracted from the obtained print data by the installed print data collection program 100 to the print suggestion device 40 via the communication network 50. Reference numeral A2 indicates a communication path of the print attribute information sent from the printer 22 to the print suggestion device 40.

As described above, in the print suggestion system 2, the print data collection program 100 is installed in one of the user terminal 12 and printer 22 so that one of them can function also as a print data collection device.

As illustrated in FIG. 9B, the print suggestion system 3 includes a print server GO and a print suggestion device 40. The user terminal 10, printer 20, and print suggestion device 40 are connected to the print server 60 via the communication network 50.

The print server 60 is a computer including a CPU and a data storage medium or the like, and includes the print data collection program 100 installed therein in addition to a print server program and a printer driver. The print server 60 temporarily stores print data received from the user terminal 10, and sends the temporarily stored print data consecutively to the printer 20. At this time, the print data obtaining unit 102 of the print data collection program 100 obtains print data the print server 60 received from the user terminal 10. The print server 60 sends print attribute information extracted from the obtained print data by the installed print data collection program 100 to the print suggestion device 40 via the communication network 50. Reference numeral A3 indicates a communication path of the print attribute information sent from the print server 60 to the print suggestion device 40.

As described above, according to this modified example, the user does not need the print data collection device 30, and the print suggestion system 2 or 3 can be configured by installing the print data collection program 100 in one of the user terminal 10, printer, 20, and print server 60, that are present in an existing network printing environment.

What is claimed is:

1. An apparatus for providing suggestions, the apparatus comprising:
a memory that stores print attribute information indicating contents of printing processes in a print attribute information database;
an obtaining unit that obtains print attribute information of a group of printing processes designated by a user from the print attribute information database;
an alternative selection unit that selects an alternative means applicable to each of the group of printing processes based on the print attribute information obtained by the obtaining unit;
an actual cost calculation unit that calculates a print cost required for the group of printing processes based on the print attribute information obtained by the obtaining unit;
an alternative cost calculation unit that calculates a print cost that would incur if the group of printing processes were executed with the alternative means selected by the alternative selection unit being applied based on the print attribute information obtained by the obtaining unit; and
a suggestion unit that presents an improvement suggestion on printing processes based on the print cost calculated by the actual cost calculation unit and the print cost calculated by the alternative cost calculation unit.

2. The apparatus according to claim 1, wherein the obtaining unit obtains, as part of the print attribute information, identification information of an application associated with a document that is an object of each printing process; and wherein
the alternative selection unit selects an alternative means based on the identification information of the application.

3. The apparatus according to claim 2, wherein the obtaining unit obtains, as part of the print attribute information, identification information of an application associated with a document that is an object of a printing process, and a file name or title of the document that is an object of the printing process; and wherein
the alternative selection unit selects an alternative means based on the identification information of the application and the file name or title of the document.

4. A system for providing suggestions, the system comprising:
a printing apparatus that executes printing processes in accordance with print command data;
a collection apparatus that collects print attribute information indicating contents of printing processes based on the print command data; and
a suggestion apparatus that presents an improvement suggestion on printing processes based on the print attribute information collected by the collection apparatus, the suggestion apparatus including:
an alternative selection unit that selects an alternative means applicable to each of the printing processes based on the print attribute information collected by the collection apparatus;
an actual cost calculation unit that calculates a print cost required for the printing processes based on the print attribute information collected by the collection apparatus;
an alternative cost calculation unit that calculates a print cost that would incur if the printing processes were executed with the alternative means selected by the alternative selection unit being applied based on the print attribute information collected by the collection apparatus; and
a suggestion unit that presents an improvement suggestion on printing processes based on the print cost calculated by the actual cost calculation unit and the print cost calculated by the alternative cost calculation unit.

5. A method for providing suggestions, the method comprising:
accessing a print attribute information database that stores print attribute information indicating contents of printing processes and obtaining print attribute information of a group of printing processes designated by a user;
selecting an alternative means applicable to each of the group of printing processes based on the obtained print attribute information;
calculating a print cost required for the group of printing processes as an actual cost based on the obtained print attribute information;
calculating a print cost that would incur if the group of printing processes were executed with the selected alternative means being applied as an alternative cost based on the obtained print attribute information; and
presenting an improvement suggestion on printing processes based on the calculated actual cost and the calculated alternative cost.

6. A computer readable medium storing a program causing a computer to execute a process for providing suggestion, the process comprising:
accessing a print attribute information database that stores print attribute information indicating contents of printing processes and obtaining print attribute information of a group of printing processes designated by a user;
selecting an alternative means applicable to each of the group of printing processes based on the obtained print attribute information;
calculating a print cost required for the group of printing processes as an actual cost based on the obtained print attribute information;
calculating a print cost that would incur if the group of printing processes were executed with the selected alternative means being applied as an alternative cost based on the obtained print attribute information; and
presenting an improvement suggestion on printing processes based on the calculated actual cost and the calculated alternative cost.
